(19) United States
(12) Patent Application Publication
(10) Pub. No.: US 2007/0248315 A1
(43) Pub. Date: Oct. 25, 2007

(54) Reproducing Device and Reproducing Method

(75) Inventor: Hiroaki Takeda, Ishikawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA JAPAN (JP)

(21) Appl. No.: 11/579,257

(22) PCT Filed: Mar. 1, 2006
(86) PCT No.: PCT/JP06/03890

§ 371 Date: Nov. 1, 2006

(30) Foreign Application Priority Data
Mar. 1, 2005 (JP) 2005-055687

(51) Int. Cl. H04N 9/802

(52) U.S. Cl. 386/77

(57) ABSTRACT

A reproducing device and method not producing any abnormal sound in fast-forward reproduction and rewind-reproduction modes and not causing any delay in a reproduction mode. In the reproducing device and method a music reproducing circuit (200) comprises a silence encoding data storage section (201) storing encoded silence data created by encoding silence by means of AAC, data selecting section (202) for selecting one of the encoded silence data and coded data inputted from outside and transmitting the selected data to a decoding section (203), and the decoding section (203) for decoding AAC coded data and generating a sound signal. By decoding the encoded silence signal at a point where the frames are discontinuous in the fast-forward reproduction mode, fade-in or fade-out is carried out at the frame discontinuous point.

### TECHNICAL FIELD

The present invention relates to a playback apparatus and a playback method for decoding encoded audio signals.

### BACKGROUND ART

A music playback apparatus has special playback functions referred to as fast-forward and high-speed rewind. For example, with MP3 (MPEG1 Audio Layer III), specification information such as bit rate and sampling rate etc. and audio data are provided each frame unit. At the time of special playback, MP3 data is then supplied discontinuously in sector units to decoding apparatus and the decoding apparatus acquires the bit rate and sampling rate for the frames at this number of sectors and performs decoding.

FIG.4 is a data format view illustrating a fast-forward operation of music playback apparatus of the related art. As shown in FIG.4, with audio playback apparatus of the related art, for example, fast-forward is implemented by a bit stream 1 being read out in a fixed period, and a fast-forward bit stream 2 then being played back in a pseudo manner. In this case, discontinuous portions are generated in a bit stream to be played back, but the generation of abnormal noise is prevented by carrying out mute processing (see, for example, Patent Document 1). The mute processing is processing that ensures that, in the event that discontinuous portions are detected in sectors, data is not decoded or outputted at discontinuous portions. Patent Document 1: Japanese Patent Application Laid-Open: No. 2004-206827.

### DISCLOSURE OF INVENTION

Problems to be Solved by the Invention

However, with this music playback apparatus of the related art, there is no consistency between the frame of the mute processing and audio signals for preceding and following frames during mute processing in the event that discontinuous portions occur in a bit stream.

Further, a method for carrying out processing to synthesize and smooth out a mute frame and audio signals for preceding and following frames with sound using a triangular window etc. can be considered. However, when this method is adopted, in the event that, for example, it is intended to smooth a frame with silence and a preceding frame with sound, data for the preceding frame has to be held internally, and thereby causes a delay in playback.

It is therefore an object of the present invention to provide a playback apparatus and a playback method where abnormal noise does not occur during fast-forward or high-speed rewind, and a delay does not occur in playback.

Means for Solving the Problem

A playback apparatus of the present invention adopts a configuration comprising a receiving section that receives a special playback instruction containing a fast-forward or high-speed rewind, a storage section that stores silence encoded data encoding silence, a decoding section that decodes encoded data and generates an audio signal, and a control section that, when a special playback instruction is given, carries out control so as to thin-out encoded data in fixed periods, replaces a part of the encoded data with silence encoded data read out from the storage section, and hands over to the decoding section.

A playback method of the present invention comprises the steps of receiving a special playback instruction containing a fast-forward or high-speed rewind, storing silence encoded data encoding silence, carrying out thin-out of encoded data in fixed periods and replacing a part of the encoded data with the silence encoded data when a special playback instruction is given, and decoding the encoded data and the silence encoded data and generating an audio signal.

According to another aspect, the present invention is a program for implementing steps of the above playback method on a computer.

Advantageous Effect of the Invention

According to the present invention, it is possible to ensure that abnormal noise does not occur at the time of special playback such as fast-forward or high-speed rewind.

### BRIEF DESCRIPTION OF THE DRAWINGS

FIG.1 is a block view showing a configuration of a music playback apparatus according to the embodiment of the present invention;

FIG.2 shows a data format for a fast-forward operation of music playback apparatus according to the embodiment;

FIG.3 shows units of encoded data for selected frame unit encoded data transmitted to a decoding section of a music playback circuit of a music playback apparatus according to the embodiment; and

FIG.4 is a data format view illustrating a fast-forward operation of a music playback apparatus of the related art.

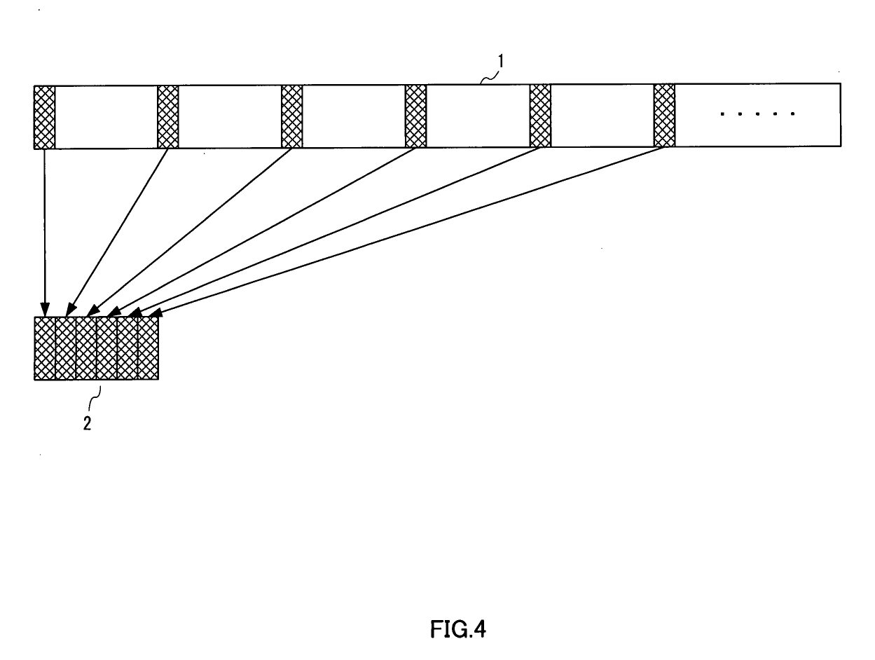

### BEST MODE FOR CARRYING OUT THE INVENTION

The preferred embodiment of the present invention will now be described in detail with reference to the drawings.

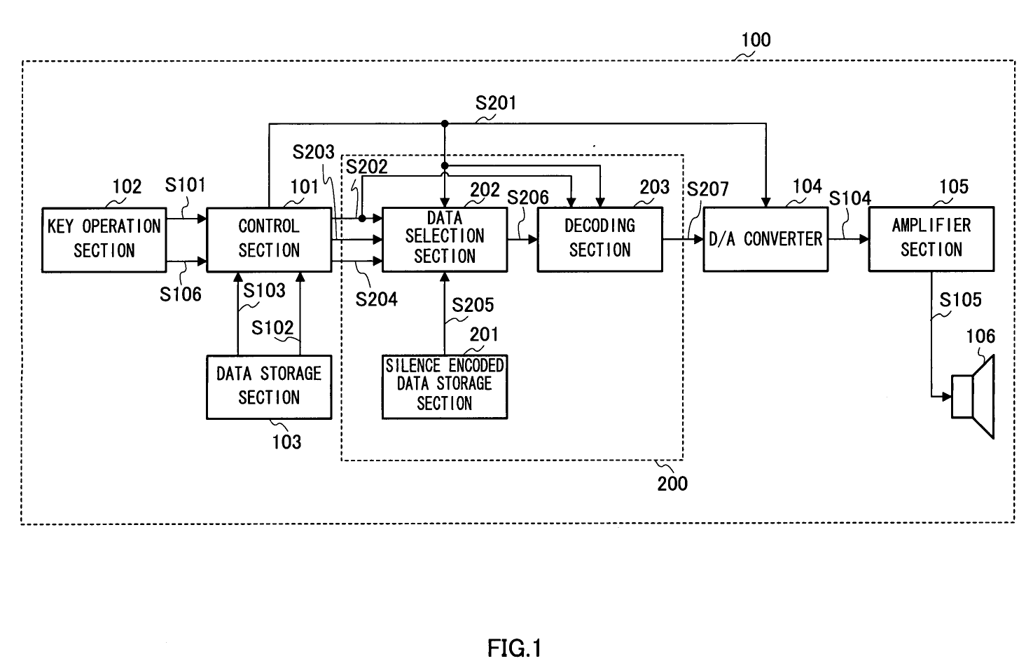

FIG.1 is a block view showing a configuration of a music playback apparatus according to the embodiment of the present invention. The playback apparatus of this embodiment are an example applied to a music playback apparatus decoding an encoded audio signal.

In FIG.1, music playback apparatus 100 is comprised of control section 101 controlling the overall apparatus, key operation section 102 operated by a user, data storage section 103 for storing encoded signals, music playback circuit 200 for playing back audio signals from encoded signals, D/A converter 104 for converting digital signals to analog signals, amplifier section 105 for amplifying analog signals, and speaker section 106 for converting amplified analog signals into sound.

Music playback circuit 200 is comprised of silence encoded data storage section 201 for storing silence encoded data where silence is encoded using AAC (Advanced Audio Coding), data selection section 202 for selecting which of silence encoded data and encoded data inputted from outside is to be transmitted to decoding section 203, and decoding section 203 for decoding AAC encoded data to generate an audio signal.

The operation of music playback apparatus 100 of the configuration described above will be described below. This embodiment adopts an example for the case of adopting AAC in an encoding scheme. This AAC may be separate from MPEG-2 and MPEG-4.

First, a normal playback method will be described. When a user operates key operation section 102 and designates normal playback, playback start instruction signal S1O1 is transmitted from key operation section 102 to control section 101. Control section 101 then reads out content information S102 described by content information played back from the moment from data storage section 103. The sampling rate and the number of channels of encoded data played back from the moment are recorded in the content information S102.

Control section 101 then initializes music playback circuit 200 and D/A converter 104. First, control section 101 transmits sampling rate instruction signal S201 and number-of-channels instruction signal S202 to data selection section 202 and decoding section 203 within music playback circuit 200. Further, control section 101 transmits sampling rate instruction signal S201 to D/A converter 104. At decoding section 203, internal states are initialized using sampling rate instruction signal S201 and number-of-channels instruction signal S202. Further, data selection section 202 records sampling rate instruction signal S201 and number-of-channels instruction signal S202 internally. On the other hand, D/A converter 104 is initialized so as to operate at a sampling rate instructed by sampling rate instruction signal S201.

Next, control section 101 reads out encoded data S103 from data storage section 103 and transmits this data in frame units to data selection section 202 within music playback circuit 200 as frame unit encoded data S203. Data selection section 202 then transmits the received frame unit encoded data S203 to decoding section 203 as selected frame unit encoded data S206. Decoding section 203 then AAC-decodes the received selected frame unit encoded data S206 so as to generate a decoded audio signal S207 and transmits the signal to D/A converter 104. D/A converter 104 then converts the received decoded audio signal S207 to analog decoded audio signal S104 and transmits the converted signal to amplifier section 105. Amplifier section 105 then transmits amplified analog decoded audio signal S105 amplified for the received analog decoded audio signal S104 to speaker section 106 so as to generate sound. The above is a normal playback operation.

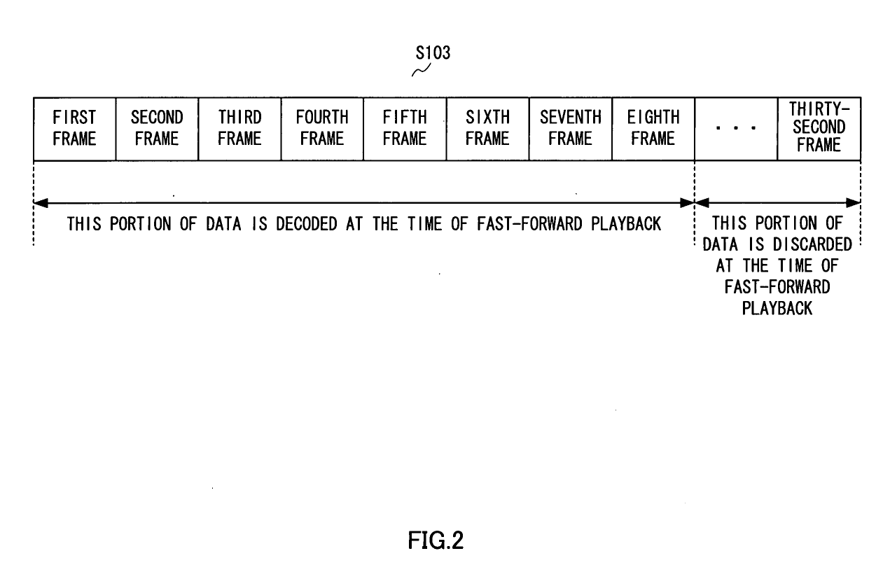

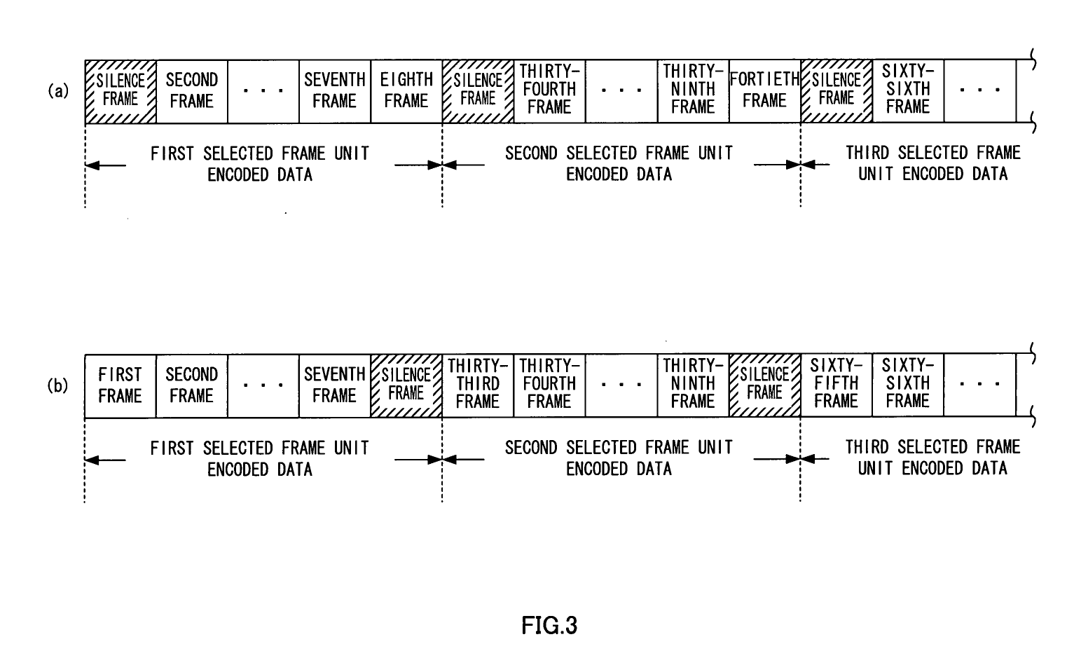

Next, the operation for the case of fast-forwarding during playback will be described using FIG.1, FIG.2 and FIG.3.

FIG.2 shows a data format for a fast-forward playback operation of music playback apparatus 100.

In the event that fast-forward playback instruction signal S106 is transmitted from key operation section 102 by a user's operation, control section 101 processes encoded data S103 after storing encoded data S103 from data storage section 103 in itself once.

A data processing method will be described using FIG.2. In the event that encoded data S103 encoded at a sampling rate of 32 kHz for content currently being played back is put together as 32 frames of AAC frame data, the sample number of one frame of AAC is 1024 samples per channel, with an audio signal of 1.024 seconds being obtained when all of the encoded data S103 is decoded. In the event that a fast-forward playback instruction occurs, control section 101 transmits sequentially the leading eight frames within encoded data S103 to music playback circuit 200 as frame unit encoded data. When transmission of the eight frames is complete, data for the remaining 24 frames is discarded and encoded data S103 is newly read out from data storage section 103. FIG. 2 shows an example where frame unit encoded data for from the leading first frame to the eighth frame is transmitted at the time of fast-forward playback, where frame unit encoded data for from the ninth frame to the thirty-second frame is discarded. This control to thin-out encoded data using fixed period units at the time of fast-forward playback is carried out repeatedly during periods of fast-forward playback. In the event of the fast-forward control described above, 32 frames are read out, but only eight frames are played back so that playback is possible at four times speed. Further, in the event that control section 101 transmits the leading frame of encoded data S103 to music playback circuit 200, special playback start signal S204 is transmitted simultaneously. In addition, this special playback start signal S204 is not transmitted in cases other than when the leading part of frame unit encoded data S203 is transmitted.

Next, the operation of music playback circuit 200 at the time of fast-forward playback will be described.

FIG.3 shows a selected frame unit encoded data transmitted to decoding section 203 of music playback circuit 200.

At the time of fast-forward playback, frame unit encoded data for the leading eight frames only is inputted at data selection section 202 of music playback circuit 200 from control section 101 shown in FIG.2.

Further, at silence encoded data storage section 201, AAC encoded data for corresponding to the sampling rates and the number of channels capable of playing back by music playback apparatus 100 and generating silence in the case of decoding by decoding section 203 is stored in advance.

In the event that data selection section 202 receives special playback start signal S204, data selection section 202 reads out silence encoded data S205 conforming to sampling rate instruction signal S201 and number-of-channels instruction signal S202 recorded internally from silence encoded data storage section 201 and transmits to decoding section 203 as selected frame unit encoded data S206. Specifically, as shown by the hatching of FIG.3(a) of the frame unit encoded data of the first to eighth frames, thirty-third to fortieth frames, and sixty-fifth to seventy-second frames . . . transmitted to decoding section 203, data selection section 202 takes the leading frames of the first frame, thirty-third frame and sixty-fifth frame . . . as silence frames through replacing with silence encoded data read out from silence encoded data storage section 201. Namely, regarding leading frames (first frame, thirty-third frame, sixty-fifth frame constituting links for selected frame unit encoded data that can become discontinuous portions, the original encoded data is replaced with silence encoded data read out from silence encoded data storage section 201 and taken to be silence frames. In this embodiment, an example has been described where leading frames are taken as silence frames, but a situation as shown in FIG.3(b) may be possible where the final frames of the eighth frame, the fortieth frame, and the seventy second frame . . . of frame unit encoded data for the first to eighth frames, thirty-third to fortieth frames, and sixty-fifth to seventy-second frames . . . transmitted to decoding section 203 are taken as silence frames is also possible.

Here, special playback start signal S204 are transmitted from control section 101 to data selection section 202 continuously while the user continues to operate the fast-forward button. Data selection section 202 carries out processing of “decode only the leading eight frames of 32 frames, and only replace the leading one frame of the decoded eight frames with silence encoded data” during the period where special playback start signal S204 is being generated.

At decoding section 203, AAC encoded data transmitted from data selection section 202 is decoded and an audio signal is generated. AAC is an audio encoding method that generates an overlapping output audio signal while carrying out windowing on the preceding and following frames on a time axis so that the decoded audio signal S207 generated using the frames makes audio signals decoded for the previous frame and silence signals overlap while carrying out windowing so as to automatically provide fading out. Further, silence encoded data S205 is decoded at the previous frame during decoding of frame unit encoded data S203 at the next frame so that windowing processing is carried out for silence signals and voiced signals so as to automatically fade in. In this way, synthesis of the preceding and following frames becomes fade-out, fade-out, so that consistency of the audio signal is maintained and generation of abnormal noise can be therefore prevented.

Processing for the generation of decoded audio signal S207 onwards in the case of fast-forward playback also is also the same as normal playback, and description thereof will be omitted.

As described above, according to this embodiment, by decoding a silence encoded signal at a point where a frame is discontinuous at the time of fast-forward playback, it is possible to carry out fade-in and fade-out at discontinuous points of a frame and implement music playback apparatus capable of suppressing the generation of abnormal noise at the time of fast-forward playback. Further, a delay does not occur in playback because the method does not hold data for the preceding frames internally.

Moreover, it is possible to suppress the generation of abnormal noise even for high-speed rewind by using the same method.

The preferred embodiments of the present invention described above are merely given as example, and the scope of the present invention is not limited to this.

Further, it is possible to apply to any apparatus that are electronic apparatus having a music playback apparatus. For example, it is possible to apply, for example, to audio playback X apparatus, mobile information terminals such as mobile telephones and PDAs (Personal Digital Assistants), and information processing apparatus such as personal computers. Further, encoded data for constituting encoding may be any kind of encoded data, sounds other than music, voice, or audio data. Further, the present invention can be applied not only to apparatus and method capable of playing back MP3 audio data, but also to apparatus and method capable of playing back other MPEG audio data.

Moreover, the present invention can be incorporated, for example, as a mobile terminal, and implemented as a mobile communication system equipped with music playback apparatus.

Further, playback apparatus and playback method is used for the title in this embodiment, but this is merely for convenience, and music playback apparatus, or audio playback methods etc. are also possible.

Moreover, the types, the numbers, and methods of connecting each circuit section constituting the music playback apparatus etc. are not limited to the embodiments described above.

Further, the playback apparatus and playback method described above can be implemented as a program to make the playback apparatus and playback method to function. This program may then be stored on a recording medium readable by computer.

This specification is based on Japanese Patent application No.2005-055687, filed on Mar. 1, 2005, the entire content of which is expressly incorporated herein by reference.

Industrial Applicability

The playback apparatus according to the present invention is capable of suppressing the generation of abnormal noise without generating delays between playback at the time of fast-forward playback and high-speed rewind playback and is therefore useful as music playback apparatus implemented on music playback equipment, information terminals, or mobile telephone equipment etc. capable of playing back music.

1. A Playback apparatus comprising:
a receiving section that receives a special playback instruction containing a fast-forward or high-speed rewind;
a storage section that stores silence encoded data encoding silence;
a decoding section that decodes encoded data and generates an audio signal; and
a control section that, when a special playback instruction is given, carries out control so as to thin-out encoded data in fixed periods, replaces a part of the encoded data with silence encoded data read out from the storage section and hands over to the decoding section.

2. The playback apparatus according to claim 1, wherein the control section thins-out frame unit encoded data transmitted in frame units in fixed periods, and of the remaining selected frame unit encoded data, replaces predetermined frames over with silence encoded data read out from the storage section.

3. The playback apparatus according to claim 1, wherein the control section replaces leading frames or final frames of the selected frame unit encoding data with silence encoded data read out from the storage section.

4. The playback apparatus according to claim 1, wherein the storage section stores silence encoded data generating silence in the event that the encoding section decodes encoded data to be played back held as content information based on the sampling rate and the number of channels.

5. The playback apparatus according to claim 1, wherein the decoding section causes overlapping while carrying out windowing on preceding and following frames on a time axis so as to generate an output audio signal.

6. A playback method comprising the steps of:
receiving a special playback instruction containing a fast-forward or high-speed rewind;
storing silence encoded data encoding silence;
carrying out thin-out of encoded data in fixed periods and replacing a part of the encoded data with the silence encoded data when a special playback instruction is given; and
decoding the encoded data and the silence encoded data and generating an audio signal.

7. A program executing the steps according to claim 6 on a computer.
